(19) United States
(12) Patent Application Publication
(10) Pub. No.: US 2026/0016327 A1
(43) Pub. Date: Jan. 15, 2026

(54) MEASURING DEVICE AND METHOD FOR PRODUCING SAME

(71) Applicant: MIB GMBH MESSTECHNIK UND INDUSTRIEBERATUNG, Breisach (DE)

(72) Inventors: Martin Deutscher, Freiburg (DE); Thomas Will, Vogtsburg (DE)

(21) Appl. No.: 18/876,069

(22) PCT Filed: Jun. 15, 2023
(86) PCT No.: PCT/EP2023/066093

§ 371 Date: Dec. 17, 2024

(30) Foreign Application Priority Data
Jun. 17, 2022 (DE) 10 2022 206 104.7

(51) Int. Cl. G01F 1/667; G01F 1/66

(52) U.S. Cl. CPC G01F 1/667; G01F 1/662

(57) ABSTRACT

In order to measure the throughflow of a medium flowing in a measuring tube (20) by means of ultrasound, a measuring device is proposed, in the case of which the measuring tube (20) is arranged in a housing (30) of the measuring device (10) between an inlet (21) and an outlet (22) for the medium, wherein at least two ultrasonic transducers (40a, 40b) which are spaced apart from one another along the measuring tube (20) are provided to ultrasonically test the medium, wherein at least one ultrasonic transducer (40a, 40b) is arranged in each end region of the measuring tube (20) in such a way that a measuring path which permits ultrasonic testing parallel to a longitudinal axis (23) of the measuring tube (20) is formed between the ultrasonic transducers (40a, 40b), wherein the housing (30) can be assembled or is assembled together with the measuring tube (20) from housing parts (30a, 30b) which are configured from at least one plastic and are produced by means of a primary forming manufacturing method, wherein the housing (30) is configured with two identical housing parts (30a, 30b) which can be connected or are connected to one another without seals by way of a welding operation, wherein channel portions (12a, 12b) which are arranged at the inlet (21) and the outlet (22) are curved in the shape of a circular arc, and wherein a centre point of that circle to which the circular arc is assigned has an eccentric offset (25) in relation to the longitudinal axis (23) of the measuring tube (20).

The invention relates to a measuring device for measuring the throughflow of a medium flowing in a measuring tube by means of ultrasound, which measuring tube is arranged in a housing of the measuring device between an inlet and an outlet for the medium. In addition, the invention relates to a production method for such a measuring device.

The measurement of throughflows by means of satisfactorily scannable measuring sections is already known for flowable media and is used in various designs. The configuration of measuring sections in housings, which can vary depending, for example, on the space available and the type of application, is known.

EP 0 681 162 A1 has disclosed a measuring device for the measurement of fluid flows with ultrasound, with a housing with connector heads leading into distribution chambers, arranged substantially coaxially to each other for the inflow and outflow of the liquid, a measuring tube connecting the distribution chambers, and with ultrasonic transducers arranged in the housing in each case in the region of the ends of the measuring tube, wherein the measuring tube is inclined with respect to the connecting axis of the connection heads. The device is made up of many parts, its sensors are in contact with the medium, the measuring tube is an insert, and there are many constantly changing cross sections and dead spaces.

DE 10 2005 041 288 A1 discloses a throughflow measuring device for measuring the flow velocity of media flowing in a pipeline, which comprises a measuring tube with ultrasonic transducers provided on each end side and connector pipes for connecting the flow measuring device onto and axially with respect to the pipeline. Due to the axiality of the connectors, the flow direction changes several times upstream of the measuring section. In addition, the production is complex due to a relatively high number of slides. Furthermore, a connecting pipe which connects the measuring pipe and the connector pipe and bends the flow path branches off from the measuring pipe at a 90° angle. The connecting pipe in question must also be closed by means of a plug, which can create capillaries/dead spaces between the connecting pipe wall and the plug. Closing also requires an additional work step.

DE 10 2008 019 989 A1 shows a measuring device, in which a measuring tube is subsequently cast around by a housing.

DE 10 2010 033 858 A1 discloses a housing for an ultrasonic measuring device of a fluid flow, comprising a fluid inlet, a fluid outlet, a measuring region with a measuring section and at least two coupling regions, in particular coupling surfaces, for an ultrasonic transducer, wherein the housing comprises two separately manufactured housing parts connected and/or connectable in the region of the measuring section, wherein the housing part comprising the fluid inlet and the housing part comprising the fluid outlet each comprise at least one coupling region. The device is complex due to differing housing parts and also provides a separate measuring tube and seals. The device also works by means of reflection of sound, with the reflectors protruding into the measuring channel. This causes turbulence that can negatively affect the measurement result, and the flow of the medium is hindered here by pressure losses.

DE 10 2014 010 375 A1 discloses an ultrasonic transducer arrangement with a pocket-shaped housing for mounting the ultrasonic transducer arrangement in a through hole in a housing of an ultrasonic water meter in a mounting plane, wherein in the housing of the ultrasonic water meter there is an ultrasonic measuring section, along which a travel time measurement can be carried out by means of the ultrasonic transducer arrangement. In this case, the measuring section with a large diameter is scanned at an angle and the respective transducers are arranged from the outside via a seal in the measuring tube, which entails a risk of leakage.

Finally, DE 10 2019 009 033 A1 shows a structural unit for arranging in a line for a fluid, with a measuring section for a throughflow meter for the fluid, and with a housing. The housing has an inlet and an outlet for the fluid. Furthermore, the housing forms a substantially straight-line throughflow section between the inlet and the outlet for the fluid. The measuring section is arranged transversely or at an angle with respect to the substantially straight-line throughflow section. This arrangement also makes it necessary to seal the pockets for the transducers, in front of which it is also likely that air will accumulate which is not entrained by the flow.

It is therefore the object of the present invention to provide a measuring device that is easy and cost-effective to produce with high reliability, and whose small number of individual parts can be assembled with reduced assembly effort.

This object is achieved by a device having the features of claim 1. The solution according to the invention therefore consists in particular in that, in the measuring device, the measuring tube is arranged in a housing of the measuring device between an inlet and an outlet for the medium, wherein at least two ultrasonic transducers spaced apart from one another along the measuring tube are provided for scanning the medium, wherein at least one ultrasonic transducer is arranged in each case in end regions of the measuring tube such that a measuring section is formed between the ultrasonic transducers, which allows scanning parallel to a longitudinal axis of the measuring tube, wherein the housing together with the measuring tube can be composed or is composed of housing parts configured from at least one plastic and produced by means of a primary forming production method, wherein the housing is configured with two identical housing parts, which can be connected or are connected to each other without a seal by a welding operation, wherein channel sections arranged at the inlet and the outlet are curved in the form of a circular arc, and wherein a center point of that circle, to which the circular arc is assigned, has an eccentric offset with respect to the longitudinal axis of the measuring tube. The measuring device according to the invention thus comprises an injection molded measuring tube, in which the scanning advantageously takes place parallel (and antiparallel) to the flow of the flowing medium. The sound path is non-reflective, capillary-free and there are no dead spaces. Furthermore, the measuring section has a virtually unchanged diameter over its entire length, which greatly reduces the corrections to be taken into account when determining the measured variable(s).

Furthermore, the arrangement according to the invention of the channel sections favors a reliable and uniform introduction of the ultrasound into the measuring section, since the center point of the circle associated with the circular arc is offset in such a way with respect to the longitudinal axis of the measuring tube that a radius of the circle runs parallel, but not coaxially, with respect to the longitudinal axis of the measuring tube. The offset is in the direction of the respective channel section here.

Preferred developments of the device according to the invention are found in the corresponding subclaims.

In one advantageous embodiment of the device according to the invention, the measuring tube can have a round, in particular circular, cross section, whereby an expedient satisfactorily scannable measuring section is produced. In particular, the measuring section is advantageously formed substantially over its entire length without a change in the cross section.

In one embodiment of the measuring device according to the invention that can be integrated highly satisfactorily into a pipeline, through which the respective medium flows, the channel sections are each provided with a connector piece at their end facing away from the measuring tube, wherein the connector pieces have a common center axis which forms a tangent of the circular arc. In this way, the inlet and outlet of the measuring device are aligned with each other.

In order to be able to arrange the transducers as exactly as possible at the ends of the measuring section so as to lie opposite each other, in one further embodiment of the ultrasonic measuring device a receptacle is provided in each of the end regions of the measuring tube on the housing or the respective housing part, in which receptacle at least the respective ultrasonic transducer can be received or is received.

In one preferred further development which ensures satisfactory accessibility of the receptacles, these are each located on the opposite end sides of the housing, i.e. in an end region of the respective housing part. The respective receptacle is particularly preferably separated from the measuring tube by a wall section of the respective housing part here, with the result that, although the respective wall section also has to be scanned, contact with the medium by the respective transducer is ruled out. The wall section preferably completely covers the cross section of the measuring tube here.

For a uniform introduction of the ultrasound into the measuring section, in one advantageous embodiment of the measuring device, the wall section is provided with a substantially constant wall thickness over the majority of the cross-sectional area of the measuring tube. This means that the wall thickness is not necessarily the same at every point of the wall section, but to such an extent that an area of constant wall thickness which covers the vast majority of the measuring tube cross section can be assumed.

In order for it to also otherwise be possible to protect the ultrasonic transducers from their environment and in order to reduce possible unintended negative influences on the measurement process, the respective receptacle can be provided in a further embodiment such that it can be closed by means of a cover part, with the result that the interior of the receptacle is insulated from the environment of the measuring device.

In order to still have access, if necessary, to the transducer or transducers or possibly other sensors in the receptacle or, in principle, to their interior, the cover part can be provided in one preferred development such that it is releasably connectable to the respective housing part. The connection between the cover part and the receptacle is possible in various configurations here. Thus, a threaded engagement can be provided between the cover and the housing, at least one of the connection partners can be prestressed by shaping against the other, or, for example, a snap and/or latching connection is provided between them. This list is not exhaustive. A sealant can be provided between the cover part and the receptacle.

The arrangement and fixing of the transducers in the respective receptacles is logically carried out here in such a way that each transducer is held on the wall section of the receptacle covering the cross section of the measuring section in a stationary manner by a fixing. For this purpose, in a further embodiment, the cover part can be assigned a stamp piece which presses at least the respective ultrasonic transducer against the wall section in the position of use. The stamp piece can also press further sensors, e.g. a temperature sensor, against the wall section here. The stamp piece can preferably be provided in a resilient or elastic manner, within limits; in addition, it is preferably provided to be rotationally movable with respect to the respective cover part. Optionally or additionally, other fixings can also be provided, e.g. transducers/sensors can be cast in the receptacle. The stamp piece can also be integrally formed with the cover part.

In one preferred development, an elastic element can also be arranged in the measuring device according to the invention between the stamp piece and the respective ultrasonic transducer, with the result that a defined but gentle type of transmission of the contact force to the ultrasonic transducer is achieved. The elastic element can be configured in the form of a piece of foam here, for example, but other embodiments are also conceivable.

In the case of fixation by means of a stamp piece, this is provided in one preferred development in a movable manner relative to the cover part, with the result that forces of a movement of the cover part are not transmitted with negative consequences to the transducer or also its cable. If the cover part is screwed, for instance, to the receptacle by means of a thread, it is advisable to provide the stamp piece in a preferably rotationally movable manner relative to the cover part. With respect to the measuring tube, and thus with respect to the transducer and possibly other sensors, the stamp piece is preferably designed such that it cannot rotate, however.

In another advantageous embodiment of the ultrasonic measuring device, the housing parts along the measuring tube can have, next to this, a closable installation space which is formed by the joining of housing parts to form the housing and is configured to receive electronic components. In this can be accommodated, for example, connectors for connecting the transducer cables to connection cables, and also measuring electronics, for example in the form of evaluation electronics or adapter boards between the mentioned cables. At least one non-volatile memory can also be arranged there, which can record and store calibration values. The installation space can be closed, for example, by a cover or a casting process.

For fixing the measuring device at an installation location, in another embodiment a fastening device can be provided at an opening edge of the installation space, by means of which fastening device the respective housing part, on which the fastening device is arranged and, via it, the entire housing, can be fixed. This can be, for example, an eyelet or a slot which are arranged in a section projecting from the housing part and are penetrated by a fixing means during fixing. In order to be able to route connection cables to the measuring device in an expedient manner and to fix them on the housing, in a further embodiment of the measuring device according to the invention, the housing parts can have a closable opening in a housing part wall. The connection cable can be routed through the relevant opening and screwed using a nut. When not in use, the opening can be closed by means of various measures, such as arranging a cover, potting or the like.

The abovementioned object is also achieved by a method for producing a measuring device for measuring the throughflow of a medium flowing in a measuring tube by means of ultrasound, in particular a measuring device as claimed in one of the preceding claims, with at least the following steps:
providing an injection mold for a housing part;
inserting a straight slide and a slide describing a circular arc portion into the injection mold, wherein a center point of the circle associated with the circular arc has an eccentric offset with respect to the longitudinal axis of the straight slide;
closing the mold and injection molding the housing part;
demolding the housing part and removing the slides;
connecting two housing parts without a seal in a welding process along a seam;
arranging ultrasonic transducers in receptacles of the housing parts.

It is also the case in the method according to the invention that the arrangement according to the invention of the channel sections favors a reliable and uniform introduction of the ultrasound into the measuring section, since the center point of the circle associated with the circular arc is offset in such a way with respect to the longitudinal axis of the measuring tube that a radius of the circle runs parallel, but not coaxially, with respect to the longitudinal axis of the measuring tube. The offset is present here in the direction of the access opening to the measuring tube, and is achieved by the arrangement of the slides formed for this purpose with the appropriate geometry.

The above embodiments and developments can be combined with each other as desired, if appropriate. Further possible embodiments, developments and implementations of the invention also include combinations, which are not explicitly mentioned, of features of the invention described in the preceding text or in the following text with respect to the exemplary embodiments.

The invention will be explained in greater detail below with reference to exemplary embodiments in the figures of the drawing, in which, in a partially schematic illustration:

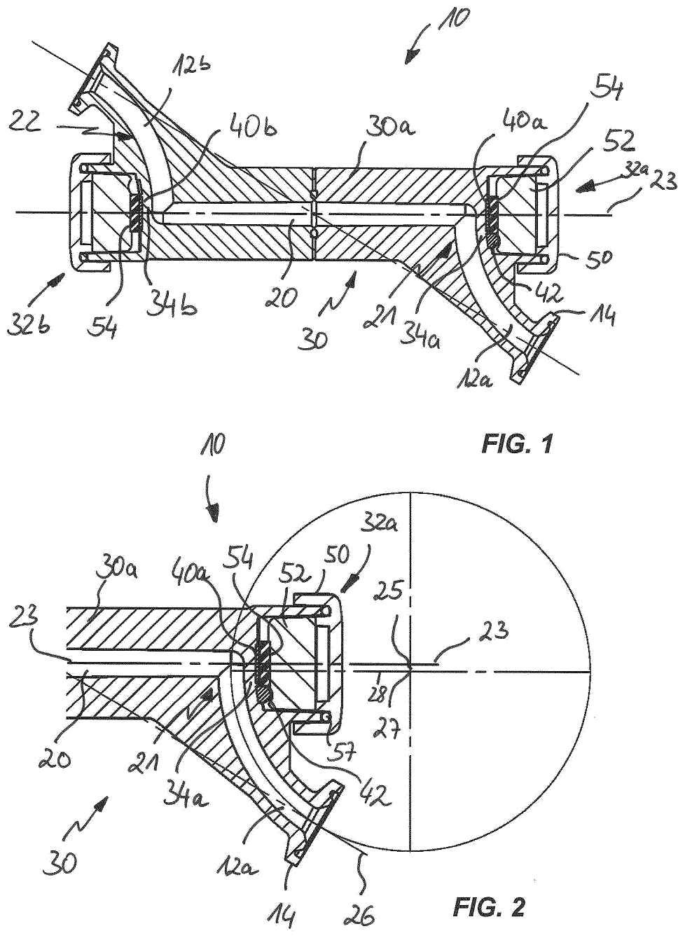

FIG. 1 shows a planar, sectioned side view of a first embodiment of a measuring device having a housing composed of two housing parts;

FIG. 2 shows an enlarged view of an end region of the measuring device from FIG. 1;

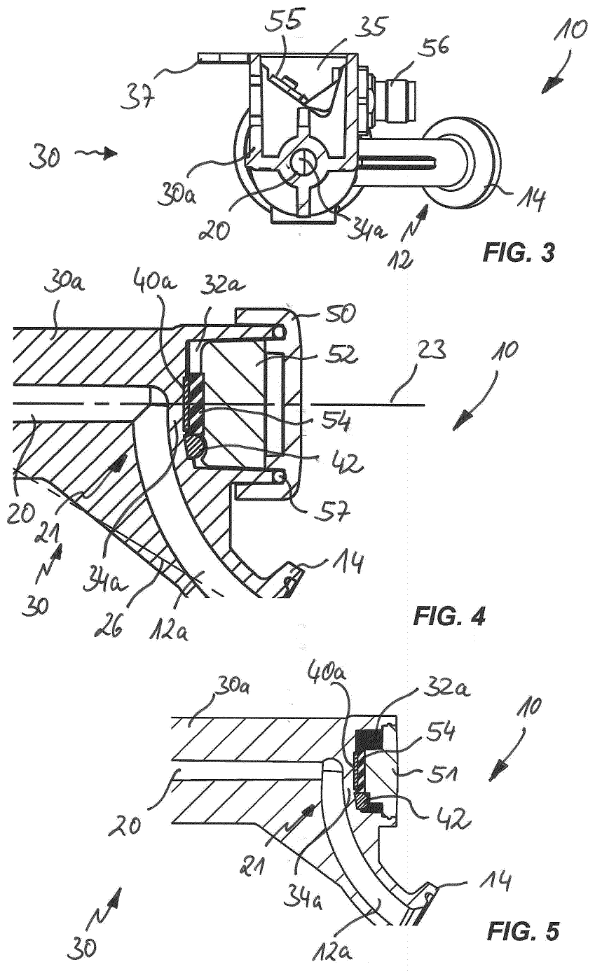

FIG. 3 shows a perspective side view of a housing part of the measuring device from FIGS. 1 and 2 toward the end face facing the other housing part (not shown);

FIG. 4 shows an enlarged detail of the illustration of the measuring device from FIG. 2 without an illustration of the circular arc;

FIG. 5 shows a planar, sectioned side view of a second embodiment of the measuring device, in which the receptacle of the housing part, in which an ultrasonic transducer and a temperature sensor are arranged, is closed by another cover part, and in which the transducer and the temperature sensor are cast in the receptacle;

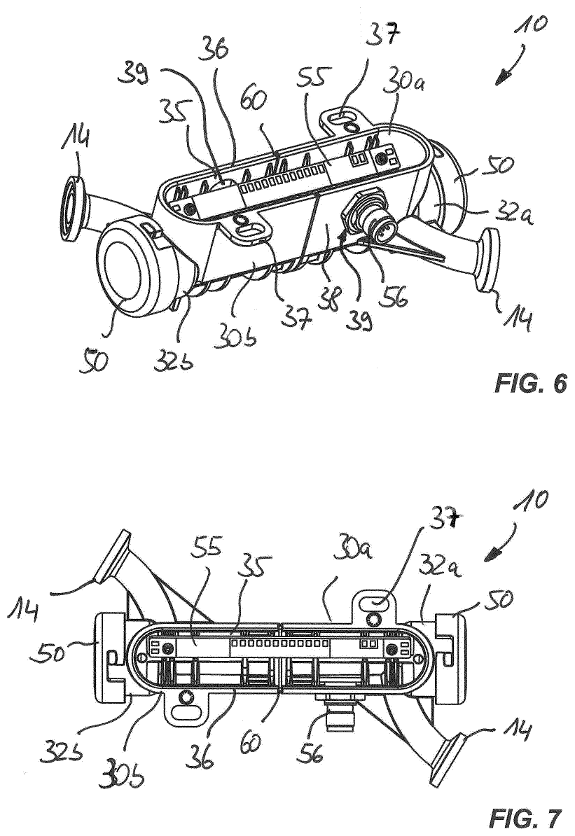

FIG. 6 shows a perspective side view of the measuring device from FIGS. 1 to 4, with fastening devices arranged on the housing parts and measuring electronics received in an installation space next to the measuring tube;

FIG. 7 shows a planar plan view from above of a measuring device from FIG. 6;

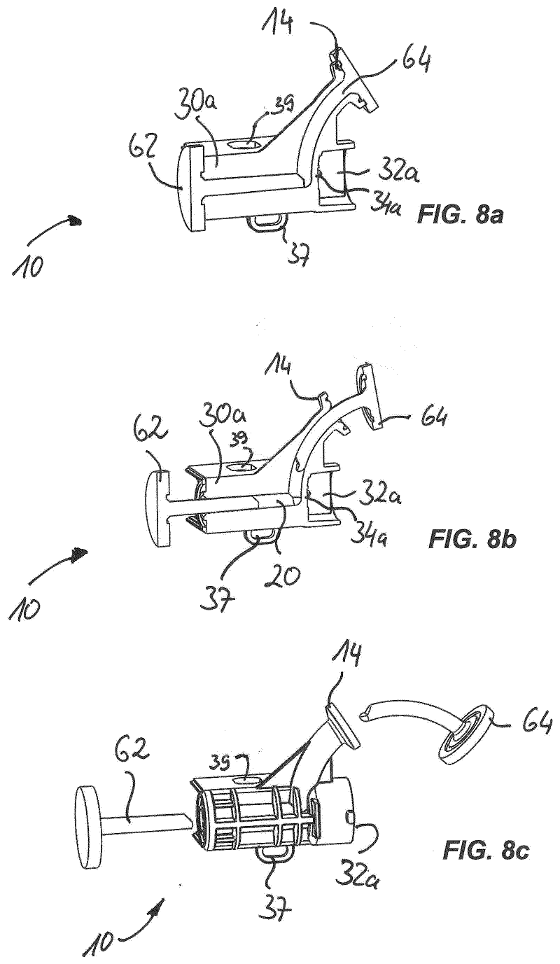

FIGS. 8a-8c each show a perspective side view of a housing part of the measuring device from FIGS. 1 to 3 and 6 and 7 when demolding by removing the slides from the injection-molded housing part.

The accompanying figures are intended to provide a further understanding of the embodiments of the invention. They illustrate embodiments and serve in conjunction with the description to explain principles and concepts of the invention. Other embodiments and many of the advantages mentioned arise with regard to the figures of the drawing. The elements of the figures of the drawing are not necessarily shown to scale with respect to each other.

In all figures, identical or functionally identical elements and devices have been provided with the same designations, unless otherwise indicated.

FIG. 1 shows a planar, sectioned side view of a first embodiment of the measuring device 10 having a housing 30 composed of two housing parts 30a, 30b. The measuring device 10 shown is provided for measuring the throughflow of a medium flowing into the measuring tube 20 by means of ultrasound. The measuring tube 20 in the housing 30 extends between the inlet 21 and the outlet 22, which supply and discharge, respectively, the medium flowing in the measuring tube. Ultrasonic transducers 40a, 40b spaced apart from one another along the measuring tube 20 are provided for scanning the medium. In this case, an ultrasonic transducer 40a, 40b is arranged in each case in end regions of the measuring tube 20 such that a measuring section is formed between the ultrasonic transducers 40a, 40b, which allows scanning parallel to a longitudinal axis 23 of the measuring tube 20. The housing 30 together with the measuring tube 20 is composed of two housing parts 30a, 30b, the housing parts 30a, 30b being produced from a plastic by means of an injection molding process. The housing 30 is configured with two identical housing parts 30a, 30b, which are connected to each other without a seal by a welding operation. As can be seen in this regard even better in FIG. 2, channel sections 12a, 12b arranged at the inlet 21 and the outlet 22 of the housing 30 are curved in the form of a circular arc, wherein a center point of that circle, to which the circular arc belongs, has an eccentric offset 25 with respect to the longitudinal axis 23 of the measuring tube 20. In this case, the center point 27 of the circle associated with the circular arc is offset in such a way with respect to the longitudinal axis 23 of the measuring tube 20 that a radius 28 of the circle runs parallel, but not coaxially, with respect to the longitudinal axis 23 of the measuring tube.

FIG. 2 shows an enlarged view of an end region of the measuring device from FIG. 1. It is seen, both in FIG. 1 and in FIG. 2, that a receptacle 32a, 32b is provided in each of the end regions of the measuring tube 20 on the housing 30, in which receptacle the respective ultrasonic transducer 40a, 40b is received. The receptacles 32a, 32b are each located on the opposite end sides of the housing 30. An ultrasonic transducer 40a, 40b is received in the receptacle, and additionally a temperature sensor 42 is received in the receptacle 32a of the housing part 30a. The receptacles 32a, 32b are closed by a pot-like cover part 50, which in each case engages over the outer wall of the receptacle. A recess at the edge of the cover part 50 forms a bayonet catch with a protrusion of the outer wall of the receptacle 32a, 32b. Since said bayonet catch has to be opened again by means of a rotary movement, the cover part 50 presses the ultrasonic transducer 40a, 40b and the temperature sensor 42 via a separate stamp piece 52 against the side of the wall section 34a, 34b facing away from the measuring tube 20. The stamp piece 52 is provided in a resilient or elastic manner, within limits; in addition, it is rotationally movable with respect to the respective cover part 50 but such that it cannot rotate relative to the respective receptacle 32a, 32b or the housing part 30, 30b. Furthermore, the resilience is achieved here by an elastic element 54 arranged between the stamp piece 52 and the ultrasonic transducer 40a.

The respective receptacle 32a, 32b is separated from the measuring tube 20 by the wall section 34a, 34b of the respective housing part 30a, 30b here. Here, the wall section 34a, 34b in each case has a constant wall thickness in the majority of the cross-sectional area of the measuring tube 20. In particular, FIG. 2 illustrates the fact that channel sections 12a, 12b of the housing 30 that are arranged at the inlet 21 and the outlet 22 are curved in the form of a circular arc, and that a center point of that circle, to which the circular arc is assigned, has an eccentric offset 25 with respect to the longitudinal axis of the measuring tube 20. By this means, the wall section 34a of the housing part 30a is approximately straight by a distance longer by the offset 25 transversely to the longitudinal axis 23 of the measuring tube 20, as a result of which the sound can be coupled into the measuring section particularly effectively parallel/antiparallel to the flow direction of the medium. Furthermore, it is seen that the channel sections 12a, 12b are each provided with a connector piece 14 at their end facing away from the measuring tube 20, wherein the connector pieces 14 have a common center axis 26 which forms a tangent of the circular arc. The center axis 26, the longitudinal axis 23 of the measuring tube 20 and the circle radius 28 are shown by broken lines in FIG. 2.

FIG. 3 shows a perspective side view of a housing part 30a of the measuring device from FIGS. 1 and 2 toward the end face facing the other housing part 30b, not shown. In particular, it is seen that the measuring tube 20 has a circular cross section. It can further be seen that there is formed on the housing 30 or on the assembled housing parts 30a, 30b a closable installation space 35 which is formed along the measuring tube 20, next to this, by the joining of the housing parts 30a, 30b to form the housing 30. The installation space 35 is offset with respect to the plane in which the cross section of measuring tube 20 and channel sections 12a, 12b is located.

FIG. 4 shows an enlarged detail of the illustration of the measuring device 10 from FIG. 2 without an illustration of the circular arc, which has been omitted for reasons of clarity to illustrate in particular the receiving region. The arrangement of the ultrasonic transducer 40a on the side of the wall section 34a facing away from the measuring tube 20 and its pressing onto this side is seen particularly well here by the interaction of cover part 50, stamp piece 52 and elastic element 54. Furthermore, it is shown particularly well in FIG. 4 that a sealant in the form of a seal 57 is arranged between cover part 50 and the edge of the receiving region 32a.

FIG. 5 shows a planar, sectioned side view of a second embodiment of the measuring device 10, in which the receptacle 32a of the housing part 30a, in which an ultrasonic transducer 40a and a temperature sensor 42 are arranged, is closed by another cover part 51. Furthermore, in the embodiment of FIG. 5, the ultrasonic transducer and the temperature sensor are cast in the receptacle. In FIG. 5, the cover part 51 itself with its end facing the inside of the receptacle 32a forms a kind of stamp piece, which presses the ultrasonic transducer 40a and the temperature sensor 42 against the wall piece. The cover part 51 enters into a latching connection with the inner edge of the receptacle 32a.

FIG. 6 shows a perspective side view of the measuring device 10 from FIGS. 1 to 4, with fastening devices 37 arranged on the housing parts 30a, 30b and measuring electronics 55 received in an installation space 35 next to the measuring tube 20. FIG. 7 shows a planar plan view from above of a measuring device 10 from FIG. 6. It is clearly seen that the installation space 35 next to the measuring tube 20 is formed by joining of the housing parts 30a, 30b to form the housing. Furthermore, it can be seen that an eyelet-like fastening device 37 is provided at the opening edge 36 of the installation space 35, by means of which the respectively associated housing part 30a, 30b, and thus, of course, also the housing 30 itself, can be fixed. In addition, it is shown that the housing parts 30a, 30b have a closable opening 39 in a housing part wall 38, through which a connector socket 56 is guided and fixed at the opening 39, as a result of which the measuring device can be connected to a signal path by means of a plug.

FIGS. 8a-8c each show a perspective side view of a housing part 30a of the measuring device 10 from FIGS. 1 to 3 and 6 and 7 when demolding by removing slides 62, 64 from the injection-molded housing part 30a. The slides 62, 64, a straight slide 62 and a slide 64 curved in the form of a circular arc had previously been inserted into an injection mold, not shown, in a method step of the production method according to the invention. In the sectioned perspective view of FIG. 8a, the slides 62, 64 can be seen in their position assumed during the injection molding operation, while, in the sectioned perspective view of FIG. 8b, they are already half pulled out of the recess in each case produced by them in the housing part 30a. In the non-sectioned perspective side view of FIG. 8c, the slides 62, 64 are completely removed from the cast housing part 30a, the straight slide 62 having produced a section of the measuring tube of the measuring device 10 and the curved slide 64 having produced the channel section 12a in the form of a circular arc. Furthermore, it can be seen that the slides 62, 64 have angularly shaped end sections which, when inserted with said end sections into the injection mold in a casting position, form a form-fitting engagement with one another in such a way that protrusion-free cross sections are formed on the measuring tube 20 and the channel sections.

After the described removal of the slides 62, 64, two housing parts 30a, 30b produced in this way can now be connected to form a housing by means of a welding operation, and the ultrasonic transducers can be placed in the receptacles 32a, 32b (not shown in FIGS. 8a-8c).

Although the present invention has been described above with reference to preferred exemplary embodiments, it is not limited to them, but can be modified in a variety of ways. In particular, the invention can be changed or modified in a variety of ways without departing from the core of the invention.

### LIST OF DESIGNATIONS

10 Measuring device
12a, 12b Channel sections
14 Connector piece
20 Measuring tube
21 Inlet
22 Outlet
23 Longitudinal axis of the measuring tube
25 Offset
26 Center axis, connector piece
27 Circle center point
28 Circle radius
30 Housing
30a, 30b Housing part
32a, 32b Receptacle
34a, 34b Wall section
35 Installation space
36 Opening edge of the installation space
37 Fastening device
38 Housing part wall
39 Opening
40a, 40b Ultrasonic transducer
42 Temperature sensor
50 Cover part
51 Cover part
52 Stamp piece
54 Elastic element
55 Measuring electronics
56 Connector socket
57 Seal
60 Seam
62 Slide, straight
64 Slide, curved

1. A measuring device (10) for measuring the throughflow of a medium flowing in a measuring tube (20) by means of ultrasound, which measuring tube (20) is arranged in a housing (30) of the measuring device (10) between an inlet (21) and an outlet (22) for the medium, wherein at least two ultrasonic transducers (40a, 40b) spaced apart from one another along the measuring tube (20) are provided for scanning the medium, wherein at least one ultrasonic transducer (40a, 40b) is arranged in each case in end regions of the measuring tube (20) such that a measuring section is formed between the ultrasonic transducers (40a, 40b), which allows scanning parallel to a longitudinal axis (23) of the measuring tube (20), wherein a receptacle (32a, 32b) is provided in each of the end regions of the measuring tube (20) on the housing (30), in which receptacle (32a, 32b) at least the respective ultrasonic transducer (40a, 40b) can be received or is received, wherein the respective receptacle (32a, 32b) is separated from the measuring tube (20) by a wall section (34a, 34b) of the respective housing part (30a, 30b), and wherein the wall section (34a, 34b) has a substantially constant wall thickness in the majority of the cross-sectional area of the measuring tube (20), the housing (30) together with the measuring tube (20) can be composed or is composed of housing parts (30a, 30b) configured from at least one plastic and produced by means of a primary forming production method, wherein the housing (30) is configured with two identical housing parts (30a, 30b), which can be connected or are connected to each other without a seal by a welding operation, characterized in that channel sections (12a, 12b) arranged at the inlet (21) and the outlet (22) are curved in the form of a circular arc and are in each case formed by means of a single curved slide (64), the outer wall of which forms the wall section (34a, 34b) facing the respective ultrasonic transducer (40a, 40b), and in that a center point (27) of that circle, to which the circular arc is assigned, has an eccentric offset (25) with respect to the longitudinal axis (23) of the measuring tube (20).

2. The measuring device as claimed in claim 1, wherein the measuring tube has a round, in particular circular, cross section.

3. The measuring device as claimed in claim 1 wherein the channel sections (12a, 12b) are each provided with a connector piece (14) at their end facing away from the measuring tube (20), wherein the connector pieces (14) have a common center axis (26) which forms a tangent of the circular arc.

4. (canceled)

5. The measuring device as claimed in claim 1, wherein the receptacles (32a, 32b) are each located on the opposite end sides of the housing (30).

6. (canceled)

7. (canceled)

8. The measuring device as claimed in claim 1, wherein the respective receptacle (32a, 32b) can be closed by means of a cover part (50).

9. The measuring device as claimed in claim 8, wherein the cover part (50) is provided such that it is releasably connectable to the respective housing part (30a, 30b).

10. The measuring device as claimed in claim 8 wherein the cover part (50) is assigned a stamp piece (52) which presses the respective ultrasonic transducer (40a, 40b) at least indirectly against the wall section (34a, 34b) in the position of use.

11. The measuring device as claimed in claim 10, wherein an elastic element (54) is arranged between the stamp piece (42) and the respective ultrasonic transducer (40a, 40b).

12. The measuring device as claimed in claim 10 wherein the stamp piece (52) is provided in a movable manner relative to the cover part (50), in particular in a rotationally movable manner and preferably such that it cannot rotate relative to the respective housing part (30a, 30b).

13. The measuring device as claimed in claim 1, wherein the housing parts (30a, 30b) along the measuring tube (20) have, next to this, a closable installation space (35) which is formed by the joining of housing parts (30a, 30b) to form the housing and is configured to receive electronic components.

14. The measuring device as claimed in claim 13, wherein a fastening device (37) is provided at an opening edge (36) of the installation space (35), by means of which fastening device (37) the respective housing part (30a, 30b) can be fixed.

15. The measuring device as claimed in claim 1, wherein the housing parts (30a, 30b) have a closable opening (39) in a housing part wall (38).

16. A method for producing a measuring device (10) for measuring the throughflow of a medium flowing in a measuring tube (20) by means of ultrasound, in particular a measuring device (10) as claimed in one of the preceding claims, with at least the following steps:
providing an injection mold for a housing part (30a, 30b);
inserting a straight slide (62) and a slide (64) describing a circular arc portion into the injection mold, wherein a center point of the circle associated with the circular arc has an eccentric offset with respect to the longitudinal axis of the straight slide (62);
closing the mold and injection molding the housing part (30a, 30b), the curved slide (64) forming a channel section (12a, 12b) of the housing part (30a, 30b) with a wall section (34a, 34b) opposite an ultrasonic transducer (40a, 40b) of the measuring device (10);
demolding the housing part (30a, 30b) and removing the slides (62, 64);
connecting two housing parts (30a, 30b) without a seal in a welding process along a seam (60);
arranging ultrasonic transducers (40a, 40b) in receptacles (32a, 32b) of the housing parts (30a, 30b).
